(19) United States
(12) Patent Application Publication
(10) Pub. No.: US 2003/0171909 A1
(43) Pub. Date: Sep. 11, 2003

(54) Logic emulator

(76) Inventors: Tomoyuki Inomoto, Iizuka (JP); Kenichi Ishida, Kasuya-Gun (JP); Tomoo Kimura, Fukuoka (JP)

Correspondence Address: WENDEROTH, LIND & PONACK, L.L.P., 2033 K STREET N. W., SUITE 800, WASHINGTON, DC, 20006-1021, US

(21) Appl. No.: 10/378,963

(22) Filed: Mar. 5, 2003

(30) Foreign Application Priority Data
Mar. 6, 2002 (JP) 2002-060839

(51) Int. Cl. G06F 9/455

(52) U.S. Cl. 703/23

(57) ABSTRACT

The output controlling circuit acquires temperature data of the variable logic elements that the temperature sensing units detect, and makes the output of the variable logic elements into high impedance where an excessive current flows into the variable logic elements and the temperature thereof excessively rises. Therefore, it is possible to prevent signals from being colliding with each other between variable logic elements, and between each of the variable logic elements and the external device, and it is possible to prevent an excessive current from continuously flowing into the variable logic elements and the external device.

### BACKGROUND OF THE INVENTION

1. Field of the Invention

The present invention relates to a logic emulator for verifying a under-verification circuit.

2. Description of the Related Art

Recently, a logic emulator is used as a device for verifying an operation of a large-scale integrated circuit (under-verification circuit) in the development of large-scale integrated circuits (LSIs).

The logic emulator is generally such that it divides a under-verification circuit, assigns the divided circuits to a plurality of variable logic elements, and is able to verify them at a high speed by actually operating them.

FIG. 12 is a block diagram of a first example of a prior art logic emulator. As shown in FIG. 12, the prior art logic emulator 501 is provided with variable logic elements 502 through 505, a variable wiring element 507 and a power supply 506.

Next, a description is given of connections thereof.

A variable logic element 502 and a variable wiring element 507 are connected to each other by a wiring 602. A variable logic element 503 and a variable wiring element 507 are connected to each other by a wiring 603. A variable logic element 504 and a variable wiring element 507 are connected to each other by a wiring 604. A variable logic element 505 and a variable wiring element 507 are connected to each other by a wiring 605. Also, respective wirings 602 through 605 are composed of a plurality of signal lines.

A power supply voltage is supplied from the power supply 506 to the variable logic elements 502 through 505 by a power supply line 512.

In addition, circuits 508 through 511 (under-verification sub-circuits, which are obtained by dividing the under-verification circuit, are assigned to the variable logic elements 502 through 505.

Further, the variable logic element 502 is connected to an external device 500 by a wiring 600. The variable logic element 503 is connected to the external device 500 by a wiring 601. Also, the respective wirings 600 and 601 are composed of a plurality of signal lines.

Next, a description is given of functions and actions of respective components.

An example of the external device 500 is described below. Various circuits and components such as LSIs, which are actually used in combination with a under-verification circuit divided and assigned to respective variable logic elements 502 through 505 of the logic emulator 501, are mounted in the external device 500.

And, the external device 500 is able to verify a under-verification circuit in a state very close to an actual use state thereof by connecting the logic emulator 501 thereto.

A description is given of another example of the external device 500. The external device 500 gives a verification test pattern to inputs of the under-verification sub-circuits 508 through 511 assigned to the respective variable logic elements 502 through 505 of the logic emulator 501.

And, the external device 500 observes outputs of the under-verification sub-circuits 508 through 511.

Here, the variable logic elements 502 through 505 of the logic emulator 501 are elements that vary the internally emulated logic, and emulate functions based on set logic.

A variable wiring element 507 emulates connections among the respective variable logic elements 502 through 505.

FIG. 13 is a block diagram of the second example of the prior art logic emulator. Also, in FIG. 13, parts which are similar to those in FIG. 12 are given the same reference numbers, and description thereof is appropriately omitted.

As shown in FIG. 13, the prior art logic emulator 701 includes variable logic elements 502 through 505 and a power supply 506.

The respective logic elements 502 through 505 are connected to each other by wirings 606 through 611.

Functions and actions of the variable logic elements 502 through 505 and the external device 500 are the same as those of the variable logic elements 502 through 505 and the external device 500, which are shown in FIG. 12.

First, the first problem is described below. In the prior art logic emulators 501 and 701, signals are caused to collide with each others at connections between the logic emulators 501 or 701 and the external device 500 due to incomplete actions of the under-verification circuit which is under development, trouble of the external device 500, or assigning mistakes of signals at connections between the external device 500 and the logic emulators 501 and 701.

Therefore, an excessive current is caused to flow to components of the connections between the variable logic elements 502 through 505 of the logic emulators 501 and 701 and the external device 500.

As a result, the variable logic elements 502 through 505 of the logic emulators 501 and 701, and components of the external device 500 are broken, and such a problem occurs, by which verification work of the under-verification circuit is hindered.

Next, a description is given of the second problem. There may be cases where the following signal collision occurs inside the prior art logic emulators 501 and 701 described above.

That is, resulting from incomplete actions of the under-verification circuit which is under development, bugs in a tool for dividing and assigning the under-verification circuit to the respective variable logic elements 502 through 505, etc., signals may collide with each other between the respective variable logic elements 502 through 505, or between each of the variable logic elements 502 through 505 and the variable wiring element 507.

Therefore, an excessive current is caused to flow to the variable logic elements 502 through 505 and to the variable wiring element 507.

Resultantly, the variable logic elements 502 through 505 of the logic emulators 501 and 701 and the variable wiring element 507 thereof are broken, wherein such a problem occurs, by which verification work of the under-verification circuit is hindered.

Next, a description is given of the third problem. There are some prior art logic emulators, which are able to detect that a consumption current of the logic emulator itself is excessive.

In the prior art logic emulator, the consumption current of individual variable logic elements and of individual variable wiring elements is not monitored, but only the consumption current of the entire logic emulator is monitored.

However, there are cases where, although the consumption current of the entire logic emulator is not excessive, the consumption current of individual variable logic elements or variable wiring elements is excessive.

Accordingly, in the prior art logic emulator, it is impossible to detect that the consumption current of individual variable logic elements or individual variable wiring elements becomes excessive.

As a result, in regard to individual variable logic elements or individual variable wiring elements, the variable logic elements or variable wiring elements of the logic emulator are broken due to flowing of an excessive consumption current, and such a problem occurs, by which verification work of the under-verification circuit is hindered.

Next, a description is given of the fourth problem. Where either the power supply 506 of the prior art logic emulators 501 and 701 or the power supply (not illustrated) of the external device 500 is turned on and the other is turned off, there may be a case where an excessive consumption current flows to components at the connections between the variable logic elements 502 through 505 of the logic emulators 501 and 701 and the external device.

As a result, the variable logic elements 502 through 505 of the logic emulator 501 and 701 and components of the external device 500 are broken, wherein such a problem occurs, by which verification work of a under-verification circuit is hindered.

### OBJECTS AND SUMMARY OF THE INVENTION

Therefore, it is an object of the present invention to provide a logic emulator that prevents an excessive current from continuously flowing, the logic emulator and external device from being damaged or broken, and is able to smoothly carry out verification work of a under-verification circuit.

Also, it is another object of the invention to provide a logic emulator that prevents an excessive current from flowing, the logic emulator and external device from being damaged or broken, and is able to smoothly carry out verification work of a under-verification circuit.

A logic emulator according to a first aspect of the invention is connected to an external device and carries out verification of a under-verification circuit, and is featured in that it is provided with a plurality of variable logic means, to which a under-verification circuit is divided and assigned, each thereof being able to alter a logic emulated therein; a plurality of temperature sensing means provided so as to correspond to a plurality of variable logic means, each thereof being able to detect the temperature of the corresponding variable logic means and convert the temperature to a quantity of electricity responsive to the temperature; and output controlling means for making the output of a variable logic means, whose temperature is detected, into high impedance when the level of the current amount responsive to the temperature reaches the prescribed level.

With such a construction, if a prescribed value is set so that, when the temperature of the variable logic means is raised, the output of the variable logic means is made into high impedance, the output of the variable logic means is made into high impedance where an excessive current flows to the variable logic means and the temperature excessively rises.

Therefore, it is possible to prevent signals from being colliding with each other between the variable logic means, between each of the variable logic means and the external device, and between each of the variable logic means and variable wiring means where any variable wiring means exists, and it is possible to prevent an excessive current from continuously flowing into the variable logic means, external device, and variable wiring means.

As a result, the logic emulator and external device can be prevented from being damaged or broken, wherein verification work of a under-verification circuit can be smoothly carried out.

A logic emulator according to a second aspect of the invention is featured in that the output controlling means makes the outputs of all the variable logic means into high impedance when the quantity of electricity responsive to the temperature of any one of the variable logic means reaches the prescribed value.

With such a construction, if the prescribed value is set so that, when the temperature of the variable logic means excessively rises, the output of the variable logic means is made into high impedance, the output of the variable logic means is made into high impedance where an excessive current flows to the variable logic means and the temperature excessively rises.

For this reason, it is possible to prevent signals from being colliding with each other between the variable logic means, between each of the variable logic means and the external device, and between each of the variable logic means and variable wiring means where any variable wiring means exists, and it is possible to prevent an excessive current from continuously flowing into the variable logic means, external device, and variable wiring means.

Resultantly, it is possible to prevent the logic emulator and external device from being damaged or broken, and verification work of a under-verification circuit can be smoothly carried out.

A logic emulator according to a third aspect of the invention is provided with a prescribed value setting means for setting a prescribed value to an optional value.

With such a construction, it becomes possible to set a prescribed value in compliance with circuits (under-verification sub-circuits) assigned to respective variable logic means by dividing the under-verification circuit, and verification environment.

In a logic emulator according to a fourth aspect of the invention, the prescribed value setting means sets the prescribed value for each of the variable logic means in response to predicted values of operating temperatures for each of the variable logic means.

With such a construction, a suitable prescribed value in response to the predicted values of operating temperatures for each of the variable logic means is compared with the quantity of electricity responsive to the temperature detected from the corresponding variable logic means.

Therefore, it is possible to further accurately detect that an excessive current flows into the variable logic means, and the temperature thereof is excessively raised.

Therefore, it is possible to further securely prevent signals from being colliding with each other between the variable logic means, between each of the variable logic means and the external device, and between each of the variable logic means and variable wiring means where any variable wiring means exists, and it is possible to further securely prevent an excessive current from continuously flowing into the variable logic means, external device, and variable wiring means.

As a result, it is possible to further securely prevent the logic emulator and external device from being damaged or broken, and verification work of a under-verification circuit can be further smoothly carried out.

In a logic emulator according to a fifth aspect of the invention, the prescribed value setting means alters the prescribed value in response to the ambient temperature of an installation place.

With such a construction, a prescribed value in response to the ambient temperature is compared with the quantity of electricity responsive to the temperature detected from the variable logic means.

Therefore, it is possible to further accurately detect that an excessive current flows into the variable logic means and the temperature thereof is excessively raised.

Accordingly, it is possible to further securely prevent signals from being colliding with each other between the variable logic means, between each of the variable logic means and the external device, and between each of the variable logic means and variable wiring means where any variable wiring means exists, and it is possible to further securely prevent an excessive current from continuously flowing into the variable logic means, external device, and variable wiring means.

As a result, it is possible to further securely prevent the logic emulator and external device from being damaged or broken, and verification work of a under-verification circuit can be further smoothly carried out.

A logic emulator according to a sixth aspect of the invention is featured in that it verifies a under-verification circuit by being connected to an external device, and it is provided with a plurality of variable logic means to which a under-verification circuit is divided and assigned, and which is able to alter the logic emulated therein; and output controlling means for making the output of a variable logic means whose quantity of electricity is detected, into high impedance when the quantity of electricity responsive to the consumption current is detected for each of the variable logic means and the detected electricity quantity reaches the prescribed value.

With such a construction, if a prescribed value is set so that the output of the variable logic means is made into high impedance when an excessive current flows into the variable logic means, the output of the variable logic means is made into high impedance when an excessive current flows into the variable logic means.

Therefore, it is possible to prevent signals from being colliding with each other between the variable logic means, between each of the variable logic means and the external device, and between each of the variable logic means and variable wiring means where any variable wiring means exists, and it is possible to prevent an excessive current from flowing into the variable logic means, external device, and variable wiring means.

As a result, the logic emulator and external device can be prevented from being broken, wherein verification work of a under-verification circuit can be smoothly carried out.

Further, no temperature of the variable logic means is used but the consumption current is used as a judging element when making the output of the variable logic means into high impedance.

As a result, without any time lag until the temperature of the variable logic means rises since a current flowing into the variable logic means becomes excessive, it is possible to detect that the current flowing into the variable logic means is excessive.

In a logic emulator according to a seventh aspect of the invention, the output controlling means makes the outputs of all the variable logic means into high impedance when the quantity of electricity responsive to the consumption current of any one of the variable logic means reaches the prescribed value.

With such a construction, if a prescribed value is set so that the output of the variable logic means is made into high impedance when an excessive current flows into the variable logic means, the output of the variable logic means is made into high impedance when an excessive current flows into the variable logic means.

It is possible to prevent signals from being colliding with each other between the variable logic means, between each of the variable logic means and the external device, and between each of the variable logic means and variable wiring means where any variable wiring means exists, and it is possible to prevent an excessive current from flowing into the variable logic means, external device, and variable wiring means.

As a result, the logic emulator and external device can be prevented from being damaged or broken, wherein verification work of a under-verification circuit can be smoothly carried out.

In a logic emulator according to an eighth aspect of the invention, the output controlling means includes prescribed value setting means for setting the prescribed value to an optional value.

With such a construction, it becomes possible to set a prescribed value in compliance with circuits (under-verification sub-circuits) assigned to respective variable logic means by dividing the under-verification circuit, and verification environment.

In a logic emulator according to a ninth aspect of the invention, the prescribed value setting means sets prescribed values for each of the variable logic means in response to predicted values of the consumption current for each of the variable logic means.

With such a construction, a suitable prescribed value in response to the predicted values of a consumption current for each of the variable logic means is compared with the quantity of electricity responsive to the consumption current detected from the corresponding variable logic means.

For this reason, it is possible to further accurately detect that an excessive current flows into the variable logic means.

Therefore, it is possible to further securely prevent signals from being colliding with each other between the variable logic means, between each of the variable logic means and the external device, and between each of the variable logic means and variable wiring means where any variable wiring means exists, and it is possible to further securely prevent an excessive current from flowing into the variable logic means, external device, and variable wiring means.

Resultantly, it is possible to further securely prevent the logic emulator and external device from being damaged or broken, wherein verification work of a under-verification circuit can be smoothly carried out.

In a logic emulator according to a tenth aspect of the invention, the output controlling means includes a plurality of overcurrent sensing means provided so as to correspond to a plurality of variable logic means, wherein the respective overcurrent sensing means senses the quantity of electricity responsive to the consumption currents of the corresponding variable logic means, and makes the output of the corresponding variable logic means into high impedance when the quantity of electricity responsive to the consumption current of the corresponding variable logic means reaches the prescribed value.

With such a construction, if the prescribed value is set so that the corresponding overcurrent sensing means makes the output of the variable logic means into high impedance when an excessive current flows into the variable logic means, the output of the variable logic means is made into high impedance when an excessive current flows into the variable logic means.

Accordingly, it is possible to prevent signals from being colliding with each other between the variable logic means, between each of the variable logic means and the external device, and between each of the variable logic means and variable wiring means where any variable wiring means exists, and it is possible to prevent an excessive current from flowing into the variable logic means, external device, and variable wiring means.

As a result, it is possible to prevent the logic emulator and external device from being damaged or broken, and verification work of a under-verification circuit can be smoothly carried out.

In a logic emulator according to an eleventh aspect of the invention, the respective variable logic means includes inputting and outputting means, which are input and output interfaces between the variable logic means and the peripheries, and logic emulating means for emulating a function based on the set logic, wherein the inputting and outputting means receives power supply voltage from a power supply differing from the power supply that supplies power supply voltage to the logic emulating means, and the output controlling means detects the quantity of electricity responsive to the consumption current for each of the inputting and outputting means, and makes the output of the inputting and outputting means, whose quantity of electricity is detected, into high impedance when the detected quantity of electricity reaches the prescribed value.

With such a construction, if the prescribed value is set so that the output of the inputting and outputting means is made into high impedance when an excessive current flows into the inputting and outputting means in the case where the inputting and outputting means and logic emulating means, which are included in the variable logic means, are given power supply voltage from different power supplies, the output of the inputting and outputting means is made into high impedance where an excessive current is caused to flow into the inputting and outputting means.

For this reason, it is possible to prevent signals from being colliding with each other between the variable logic means, between each of the variable logic means and the external device, and between each of the variable logic means and variable wiring means where any variable wiring means exists, and it is possible to prevent an excessive current from flowing into the variable logic means, external device, and variable wiring means.

As a result, the logic emulator and external device can be prevented from being damaged or broken, wherein verification work of a under-verification circuit can be smoothly carried out.

A logic emulator according to a twelfth aspect of the invention, connected to an external device, for carrying out verification of a under-verification circuit includes: a plurality of variable logic means, to which a under-verification circuit is divided and assigned, for altering the logic emulated therein; power supply ON and OFF sensing means for sensing ON-OFF states of the power supply of the external device and ON-OFF state of the power supply of the variable logic means; and switching means for connecting the variable logic means and external device to each other only when both the power supply of the external device and that of the variable logic means are turned on.

With such a construction, when one of the power supply of the external device and the power supply of the variable logic means is turned off while the other thereof is turned on, the variable logic means and the external device are not connected to each other.

Therefore, it is possible to prevent an excessive current from flowing via a wiring, by which the variable logic means and external device are connected, from the side where the power supply is turned on to the side where the power supply is turned off when one of the power supply of the external device and the power supply of the variable logic means is turned off while the other thereof is turned on.

Resultantly, the respective variable logic means and external device can be prevented from being damaged or broken, wherein verification work of a under-verification circuit can be smoothly carried out.

The above, and other objects, features and advantages of the present invention will become apparent from the following description read in conjunction with the accompanying drawings, in which like reference numerals designate the same elements.

### BRIEF DESCRIPTION OF THE DRAWINGS

FIG. 1 is a block diagram of a logic emulator according to Embodiment 1 of the present invention;

FIG. 2 is a block diagram of a logic emulator according to Embodiment 2 of the present invention;

FIG. 3 is a block diagram of a logic emulator according to Embodiment 3 of the present invention;

FIG. 4 is a block diagram of a logic emulator according to Embodiment 4 of the present invention;

FIG. 5 is a view illustrating an overcurrent sensing circuit of FIG. 4;

FIG. 6 is a view illustrating a reference voltage generating circuit of FIG. 5;

FIG. 7 is a view illustrating another reference voltage generating circuit of FIG. 6;

FIG. 8 is a block diagram of a logic emulator according to Embodiment 5 of the present invention;

FIG. 9 is a block diagram of a variable logic element of FIG. 8;

FIG. 10 is a block diagram of a logic emulator according to Embodiment 6 of the present invention;

FIG. 11 is a view illustrating a bus switch of FIG. 10;

FIG. 12 is a view illustrating a prior art logic emulator; and

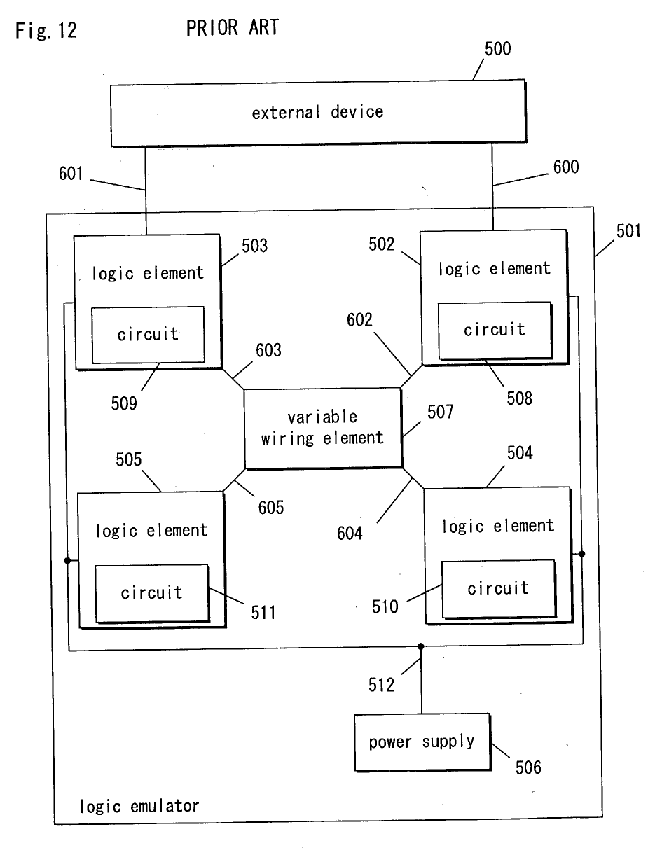

FIG. 13 is a view illustrating another prior art logic emulator.

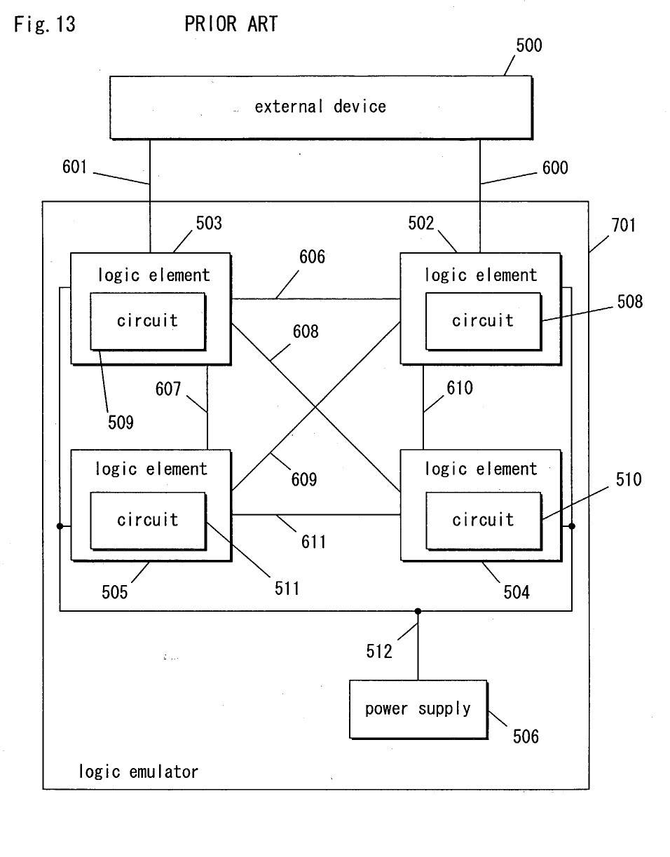

### DETAILED DESCRIPTION OF THE PREFERRED EMBODIMENTS

Hereinafter, a description is given of embodiments of the invention with reference to the accompanying drawings.

(Embodiment 1)

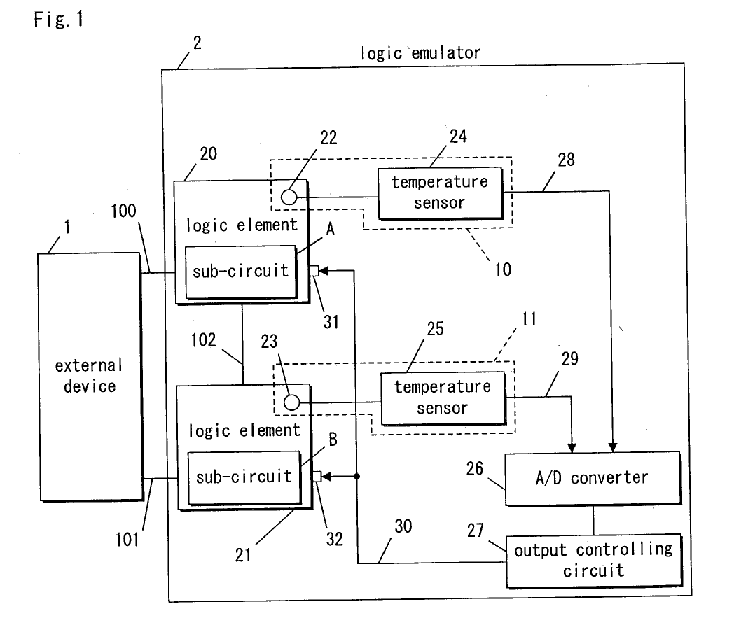

FIG. 1 is a block diagram of a logic emulator according to Embodiment 1 of the present invention.

As shown in FIG. 1, the logic emulator 2 includes variable logic elements 20 and 21, temperature sensing units 10 and 11, an A/D converter 26, and an output controlling circuit 27.

The temperature sensing unit 10 includes a temperature sensor 24 and a probe 22. The probe 22 is attached to the package of the variable logic element 20.

The temperature sensing unit 11 includes a temperature sensor 25 and a probe 23. The probe 23 is attached to the package of the variable logic element 21.

A circuit (hereinafter called a “under-verification circuit” in the embodiments) to be verified by the logic emulator 2 is divided and assigned to the variable logic elements 20 and 21.

In detail, a sub-circuit A (hereinafter called a “under-verification sub-circuit” in the embodiments) obtained by dividing the under-verification circuit is assigned to the variable logic element 20. A under-verification sub-circuit B is assigned to the variable logic element 21.

Further, there is an LSI as one example of a under-verification circuit. In the embodiments, an LSI is taken for instance as the under-verification circuit.

Next, a description is given of connections.

The temperature sensor 24 is connected to the A/D converter 26 by a wiring 28, and output signals of the temperature sensor 24 are given to the A/D converter 26.

The temperature sensor 25 is connected to the A/D converter 26 by a wiring 29, and output signals of the temperature sensor 25 are given to the A/D converter 26.

The output controlling circuit 27 is connected to output enable terminals 31 and 32 (hereinafter called “OE terminals”) of the variable logic elements 20 and 21 by a wiring 30, and control signals generated by the output controlling circuit 27 are given to the OE terminals 31 and 32. The wiring 30 includes a plurality of signal lines.

The variable logic element 20 and variable logic element 21 are connected to each other by a wiring 102. The wiring 102 includes a plurality of signal lines.

The variable logic element 20 and external device 1 are connected to each other by a wiring 100. The wiring 100 includes a plurality of signal lines.

The variable logic element 21 and external device 1 are connected to each other by a wiring 101. The wiring 101 includes a plurality of signal lines.

Next, a description is given of functions and actions of respective components. First, the external device 1 is explained below.

A description is given of one example of the external device 1. A under-verification circuit divided and assigned to respective variable logic elements 20 and 21 of the logic emulator 2 and various circuits and components such as an LSI actually used in combination with the under-verification circuit are mounted in the external device 1.

And, the external device 1 is constructed so as to enable verification of a under-verification circuit in a state very close to an actual use state by connecting the logic emulator 2 thereto.

A description is given of another example of the external device 1. The external device 1 gives a verification test pattern to inputs of the under-verification sub-circuits A and B assigned to the respective variable logic elements 20 and 21 of the logic emulator 2. And, the external device 1 observes outputs of the under-verification sub-circuits A and B.

Next, a description is given of the logic emulator 2. The variable logic elements 20 and 21 are those operable to alter the logic emulated therein and emulate functions based on the set logic.

In detail, the variable logic elements 20 and 21 are combinations of a circuit operable to program functions (logic cell), a signal line (program wiring) operable to program a connection state, and a programmable input/output circuit (program I/O).

For example, the variable logic elements 20 and 21 are FPGA (Field Programmable Gate Arrays).

The temperature sensors 24 and 25 convert the detected temperatures of the variable logic elements 20 and 21 to voltages proportionate to the temperatures and give the same to the A/D converter 26.

Also, the temperature sensors 24 and 25 detect the temperatures of the variable logic elements 20 and 21 by the probes 22 and 23 attached to the variable logic elements 20 and 21 that are objects to be measured.

The A/D converter 26 converts analog signals into digital signals, and gives the digital signals to the output controlling circuit 27.

In detail, the A/D converter 26 converts voltages (analog signals), which are proportionate to the temperature inputted by the temperature sensors 24 and 25, into digital signals (hereinafter called “temperature data”), and gives the same to the output controlling circuit 27.

The output controlling circuit 27 monitors the temperature data of the respective variable logic elements 20 and 21, which are read from the A/D converter 26.

And, the output controlling circuit 27 gives a control signal operable to make the output of a variable logic element into high impedance via a wiring 30 to the OE terminal of the corresponding variable logic element, whose temperature data exceeding a prescribed threshold is detected, when the level of the monitoring temperature data exceeds the prescribed threshold. The corresponding variable element makes the output into high impedance on the basis of the control signal.

In addition, the output controlling circuit 27 is able to make the outputs of all the variable logic elements 20 and 21 into high impedance when the level of temperature data detected from any one of the variable logic elements 20 and 21 exceeds the prescribed threshold.

Herein, the prescribed threshold is defined in view of the following points. If signals are collided with each other between the variable logic element 20 and the variable logic element 21, or between each of the variable logic elements 20 and 21 and external device 1, the current flowing into the variable logic elements 20 and 21 becomes excessive.

If so, the temperatures of the variable logic elements 20 and 21 rise. That is, by monitoring the temperatures of the variable logic elements 20 and 21, it can be detected that an excessive current flows into the variable logic elements 20 and 21. The present embodiment utilizes this point.

Where the temperatures of the variable logic elements 20 and 21 become higher than that in a normal operating state, it can be predicted that an excessive current is flowing into the variable logic elements 20 and 21. The normal operating state means an appropriate operating state when no excessive current is flowing into the variable logic elements 20 and 21.

Therefore, the prescribed threshold is set to a value responsive to the temperature in the normal operating state of the variable logic elements 20 and 21.

Thereby, where an excessive current flows into the variable logic elements 20 and 21 and the temperature thereof exceeds the temperature in the normal operating state, the outputs of the variable logic elements 20 and 21 are made into high impedance.

For this reason, it is possible to prevent signals from being colliding with each other between the variable logic elements 20 and 21, and between each of the variable logic elements 20 and 21 and the external device 1, wherein it is possible to prevent an excessive current from flowing into the variable logic elements 20 and 21 and the external device 1.

As a result, it is possible to prevent the logic emulator 2 and external device 1 from being damaged or broken, and verification work of a under-verification circuit can be smoothly carried out.

Here, for example, it is possible to determine the prescribed threshold on the basis of experience. Also, the prescribed threshold may be determined for each of the variable logic elements 20 and 21. In addition, the prescribed threshold may be defined to be common to the variable logic elements 20 and 21.

On the other hand, the output controlling circuit 27 gives a control signal, which brings about a state of enabling verification work (that is, a normal state), via the wiring 30 to the OE terminals 31 and 32 of the variable elements 20 and 21 when the level of the monitoring temperature data does not exceed the prescribed threshold. The variable logic element that receives the control signal is made into a normal state.

The output controlling circuit 27 as described above may be composed of, for example, a microcomputer. In this case, a process made by the above-described output controlling circuit 27 is carried out by programs in a microcomputer.

Now, as described above, in the embodiment, the output controlling circuit 27 makes the outputs of the variable logic elements 20 and 21, the temperatures of which are detected, into high impedance when the levels of the temperature data (quantity of electricity responsive to the temperatures) detected from the variable logic element 20 and 21 exceeds the prescribed threshold.

Accordingly, if the prescribed threshold is set so that the outputs of the variable logic elements 20 and 21 are made into high impedance when the temperatures of the variable logic elements 20 and 21 excessively rise, the outputs of the variable logic elements 20 and 21 are made into high impedance where an excessive current flows into the variable logic elements 20 and 21 and the temperature thereof is excessively raised.

For this reason, it is possible to prevent signals from being colliding with each other between the variable logic elements 20 and 21, and between each of the variable logic elements 20 and 21 and the external device 1, wherein it is possible to prevent an excessive current from flowing into the variable logic elements 20 and 21 and the external device 1.

As a result, it is possible to prevent the logic emulator 2 and the external device 1 from being damaged or broken, wherein verification work of a under-verification circuit can be smoothly carried out.

The effect can be displayed, as in the above, even where all the variable logic elements 20 and 21 are made into high impedance when the level of the temperature data (quantity of electricity responsive to the temperature) detected from any one of the variable logic elements 20 and 21 exceeds a prescribed threshold.

(Embodiment 2)

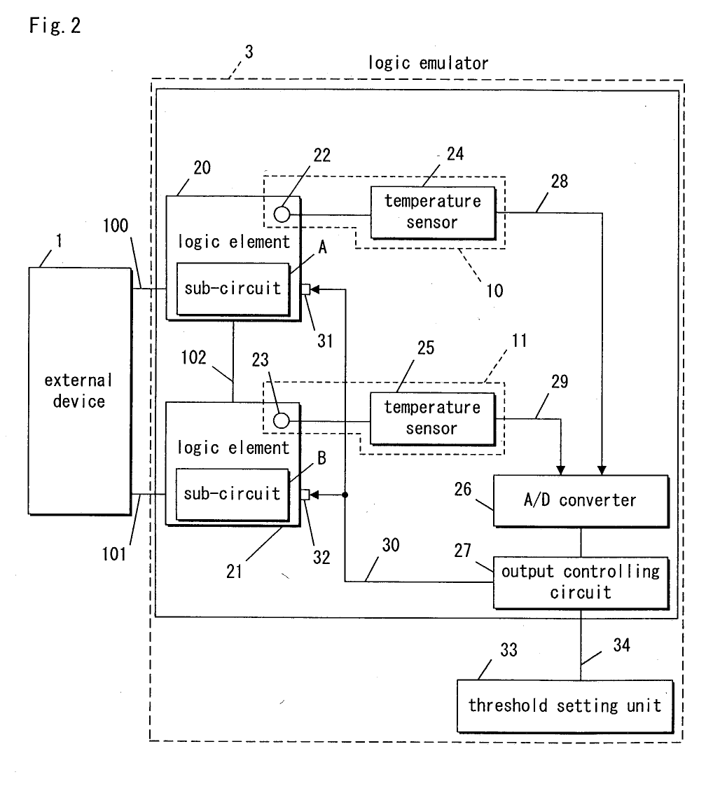

FIG. 2 is a block diagram of a logic emulator according to Embodiment 2 of the present invention. Also, in FIG. 2, parts which are similar to those in FIG. 1 are given the same reference numbers, and description thereof is appropriately omitted.

As shown in FIG. 2, a logic emulator 3 according to Embodiment 2 is such that a threshold setting unit 33 is added to the construction of the logic emulator 2 shown in FIG. 1.

And, the output controlling circuit 27 and the threshold setting unit 33 are connected to each other by a wiring 34.

Next, a description is given of functions and actions of the logic emulator 3. In the present embodiment, a user of the logic emulator 3 is able to alter a prescribed threshold with respect to temperature data, which the output controlling circuit 27 monitors, by the threshold setting unit 33. Also, the temperature data are temperature data of the variable logic elements 20 and 21.

In detail, when a user inputs a new prescribed threshold in the threshold setting unit 33, the threshold setting unit 33 gives data expressing a newly inputted prescribed threshold to the output controlling circuit 27 by the wiring 34.

If so, the output controlling circuit 27 alters the present prescribed threshold to a new prescribed threshold, and hereafter carries out comparison of the altered prescribed threshold with the temperature data to be monitored.

Here, as in Embodiment 1, the prescribed thresholds are set responsive to the temperatures of the variable logic elements 20 and 21 in a normal operating state.

However, there may be cases where an appropriate prescribed threshold is not necessarily obtained for all types of under-verification circuits if the prescribed threshold is determined at a fixed value since the logic emulator 2 verifies various types of under-verification circuits. Also, there may be cases where the appropriate prescribed threshold changes to verification environments (for example, installation place of the logic emulator) even if the same type of a under-verification circuit is verified.

Therefore, the embodiment is constructed so that the prescribed threshold can be set to an optional value by the threshold setting unit 33.

Thus, an appropriate prescribed threshold can be set to various types of under-verification circuits, and the verification environment can be taken into consideration.

In addition, the prescribed threshold may be defined for each of the variable logic elements 20 and 21, and may be defined to be common to the variable logic elements 20 and 21.

Since the prescribed thresholds can be determined in compliance with the under-verification sub-circuits A and B assigned to the respective variable logic elements 20 and 21 where the prescribed threshold is defined for each of the variable logic elements 20 and 21, a further appropriately prescribed threshold may be used.

Here, as one example, the above-described output controlling circuit 27 may be composed of a microcomputer, and the threshold setting unit 33 may be composed of a workstation. In this case, a process in the output controlling circuit 27 can be carried out by programs in the microcomputer, and a process in the threshold setting unit 33 can be carried out by programs in the workstation.

Where the above is taken for instance, the serial port of the output controlling circuit 27 is connected to the serial port of the threshold setting unit 33 by a wiring 34.

And, as the threshold setting unit 33 transmits a new prescribed threshold inputted by a user to the output controlling circuit 27, the output controlling circuit 27 alters the present prescribed threshold to a new prescribed threshold by the programs thereof. Hereafter, the altered prescribed threshold is compared with the temperature data to be monitored.

As described above, in the present embodiment, the output controlling circuit 27 makes the outputs of the variable logic elements 20 and 21, the temperatures of which are detected, into high impedance when the levels of temperature data (quantity of electricity responsive to the temperatures) detected from the variable logic elements 20 and 21 exceed the prescribed threshold.

Further, the embodiment is provided with a threshold setting unit 33 for setting the prescribed threshold to an optional value by an instruction of a user.

For this reason, it becomes possible to set prescribed thresholds in response to the under-verification sub-circuits A and B, and verification environment.

Therefore, appropriate prescribed thresholds responsive to the under-verification sub-circuits A and B and verification environment can be compared with the temperature data (quantity of electricity responsive to the temperatures) detected from the variable logic elements 20 and 21.

Accordingly, it is possible to further accurately detect that an excessive current flows into the variable logic elements 20 and 21 and the temperatures thereof excessively rise.

Therefore, it is possible to further securely prevent signals from being colliding with each other between the variable logic elements 20 and 21, and between each of the variable logic elements 20 and 21 and the external device 1, wherein it is possible to further securely prevent an excessive current from continuously flowing into the variable logic elements 20 and 21 and external device 1.

Resultantly, it is possible to further securely prevent the logic emulator 3 and external device 1 from being damaged or broken, wherein verification work of the under-verification circuit can be smoothly carried out.

Next, a description is given of a modified version of the logic emulator according to the present embodiment.

In the modified version, the threshold setting unit 33 predicts operating temperatures of the individual variable logic elements 20 and 21 on the basis of information of the under-verification sub-circuits A and B assigned to the individual variable logic elements 20 and 21.

The operating temperatures of the variable logic elements 20 and 21 are predicted from, for example, the circuit scale of the under-verification sub-circuits A and B and operation frequencies of the under-verification sub-circuits A and B.

And, the threshold setting unit 33 calculates prescribed thresholds responsive to the predicted operating temperatures for the respective variable logic elements 20 and 21, and gives data expressing the prescribed thresholds to the output controlling circuit 27.

If so, the output controlling circuit 27 alters the present prescribed thresholds for the respective variable logic elements 20 and 21 to new prescribed thresholds for the respective variable logic elements 20 and 21. After that, the altered prescribed thresholds are compared with the temperature data to be monitored.

Here, the output controlling circuit 27 in the above-described modified version may be composed of a microcomputer as one example, and the threshold setting unit 33 in the modified version may be composed of a workstation. In this case, a process in the output controlling circuit 27 can be carried out by programs in the microcomputer, and a process in the threshold setting unit 33 can be carried out by programs in the workstation.

According to the example, the operating temperatures of individual variable logic elements 20 and 21 are predicted by programs in the threshold setting unit 33 on the basis of information of under-verification sub-circuits A and B assigned to the individual variable logic elements 20 and 21.

And, the threshold setting unit 33 calculates prescribed thresholds responsive to the predicted operating temperatures for the respective variable logic elements 20 and. 21, and gives data expressing the prescribed thresholds to the output controlling circuit 27.

Thereby, the output controlling circuit 27 alters the present prescribed thresholds for the respective variable logic elements 20 and 21 to new prescribed thresholds for the respective variable logic elements 20 and 21. After that, the altered prescribed thresholds are compared with the temperature data to be monitored.

As described above, in the modified version, the threshold setting unit 33 sets prescribed thresholds for the respective variable logic elements 20 and 21 in response to predicted values of the operating temperatures of the variable logic elements 20 and 21.

Thereby, appropriately prescribed thresholds responsive to the predicted values of the operating temperatures for the respective variable logic elements 20 and 21 are compared with the temperature data (the quantity of electricity responsive to the temperatures) detected from the corresponding variable logic elements 20 and 21.

Therefore, it is possible to further accurately detect that an excessive current flows into the variable logic elements 20 and 21 and the temperatures excessively rise.

Accordingly, it is possible to further securely prevent signals from being colliding with each other between the variable logic elements 20 and 21, and between each of the variable logic elements 20 and 21 and the external device 1, wherein it is possible to further securely prevent an excessive current from flowing into the variable logic elements 20 and 21 and the external device 1.

As a result, it is possible to further securely prevent the logic emulator 3 and the external device 1 from being damaged or broken, wherein verification work of a under-verification circuit can be smoothly carried out.

In addition, in the modified version, the threshold setting unit 33 predicts the operating temperatures of the variable logic elements 20 and 21. Accordingly, it is possible to reduce time and effort assigned to a user of a logic emulator 3 as much as possible.

(Embodiment 3)

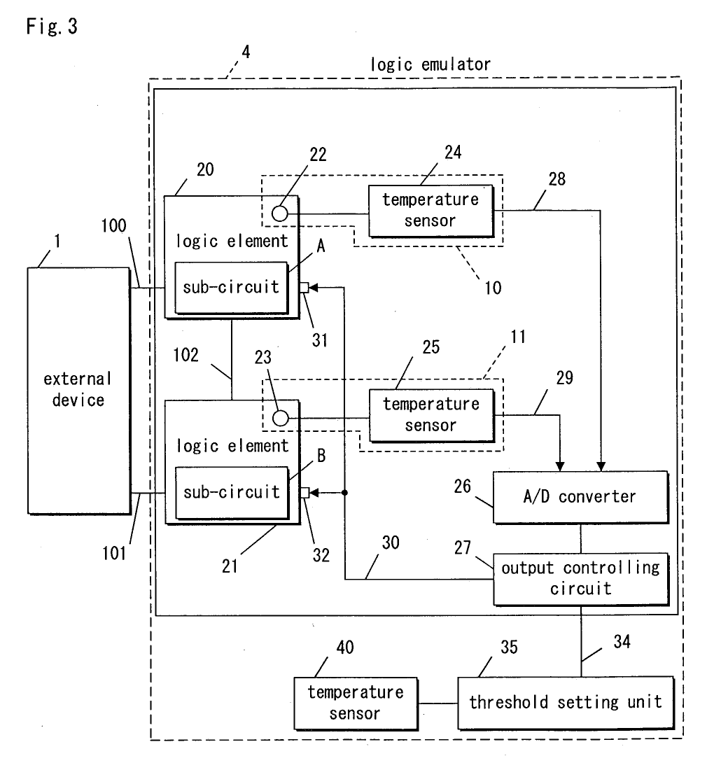

FIG. 3 is a block diagram of a logic emulator according to Embodiment 3 of the present invention. Also, in FIG. 3, parts which are similar to those in FIG. 1 are given the same reference numbers, and description thereof is appropriately omitted.

As shown in FIG. 3, a logic emulator 4 according to Embodiment 3 is such that a threshold setting unit 35 and a temperature sensor 40 are added to the construction of the logic emulator 2 in FIG. 1.

And, the output controlling circuit 27 is connected to the threshold setting unit 35 by a wiring 34.

Next, a description is given of functions and actions of the logic emulator 4 according to the present embodiment.

The threshold setting unit 35 corrects a prescribed threshold with respect to the temperature data monitored by the output controlling circuit 27 on the basis of data of the ambient temperature data obtained from the temperature sensor 40. In addition, the temperature data are temperature data of the variable logic elements 20 and 21.

And, the threshold setting unit 35 gives the corrected prescribed threshold to the output controlling circuit 27.

Thereby, the output controlling circuit 27 compares the corrected prescribed threshold with the temperature data to be monitored.

Also, a prescribed threshold that becomes an object to be corrected may be defined for each of the variable logic elements 20 and 21, or a prescribed threshold may be defined to be common to the respective variable logic elements 20 and 21. In any case, the prescribed threshold may be corrected in response to the ambient temperature.

Further, the prescribed threshold that becomes an object of correction is set to a value responsive to the temperature in a normal operating state of the variable logic elements 20 and 21 as in Embodiment 1.

Here, the above-described output controlling circuit 27 may be composed of a microcomputer as one example, and the threshold setting unit 35 may be composed of a workstation. In this case, a process in the output controlling circuit 27 can be carried out by programs in the microcomputer, and a process in the threshold setting unit 35 can be carried out by programs in the workstation.

According to the example, the threshold setting unit 35 corrects a prescribed threshold with respect to the temperature data, which are monitored by the output controlling circuit 27, by programs on the basis of data of the ambient temperature obtained from the temperature sensor 40.

And, the threshold setting unit 35 transmits the corrected prescribed threshold to the output controlling circuit 27.

Thereby, the output controlling circuit 27 compares the corrected prescribed threshold with the temperature data to be monitored.

Also, in the example, the serial port of the output controlling circuit 27 is connected to the serial port of the threshold setting unit 35 by the wiring 34.

As described above, in the present embodiment, the output controlling circuit 27 makes the outputs of the variable logic elements 20 and 21, the temperatures of which are detected, into high impedance when the levels of the temperature data (the quantity of electricity responsive to the temperatures) detected from the variable logic elements 20 and 21 exceed the prescribed threshold.

Further, in the embodiment, the threshold setting unit 35 corrects the prescribed threshold in response to the ambient temperature in the installation place of the logic emulator 4, and alters the prescribed threshold to the corrected prescribed threshold with respect to the output controlling circuit 27.

Therefore, an appropriate prescribed threshold responsive to the ambient temperature is compared with the temperature data (the quantity of electricity responsive to the temperature) detected from the variable logic elements 20 and 21.

For this reason, it is possible to further accurately detect that an excessive current flows into the variable logic elements 20 and 21 and the temperatures thereof excessively rise.

Accordingly, it is possible to further securely prevent signals from being colliding with each other between the variable logic elements 20 and 21, and between each of the variable logic elements 20 and 21 and the external device 1, wherein it is possible to further securely prevent an excessive current from continuously flowing into the variable logic elements 20 and 21 and external device 1.

As a result, it is possible to further securely prevent the logic emulator 4 and external device 1 from being damaged or broken, wherein verification work of a under-verification circuit can be smoothly carried out.

Also, the number of variable logic elements is not limited to two. That is, Embodiments 1 through 3, and the modified version of Embodiment 2 may be applied to a case where the number of variable logic elements is an optional figure.

In addition, Embodiments 1 through 3, and the modified version of Embodiment 2 may be applied to a case where all the variable logic elements are not connected to the external device.

Also, Embodiments 1 through 3, and the modified version of Embodiment 2 may be even applied to a case where connections between the respective variable logic elements are achieved by using an exclusive variable wiring element. The variable wiring element is, for example, FPID (Field Programmable Interconnecting Device).

Further, in Embodiments 1 through 3, and the modified version of Embodiment 2, a case where the temperatures of variable logic elements are raised is taken for instance as a cause of collisions of signals. However, it is as a matter of course that, even if the cause of a temperature rise is other than the collisions of signals, Embodiments 1 through 3, and the modified version of Embodiment 2 can bring about and display effects similar to the above.

(Embodiment 4)

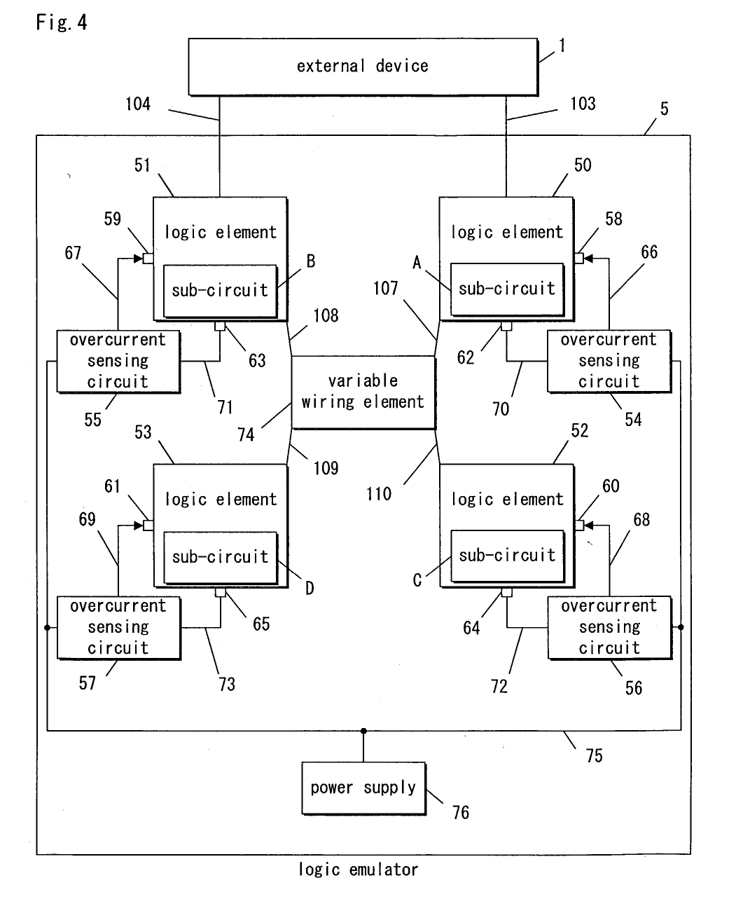

FIG. 4 is a block diagram of a logic emulator according to Embodiment 4 of the present invention. Also, in FIG. 4, parts which are similar to those in FIG. 1 are given the same reference numbers, and description thereof is appropriately omitted.

As shown in FIG. 4, the logic emulator 5 includes variable logic elements 50 through 53, a power supply 76, a variable wiring element 74, and overcurrent sensing circuits 54 through 57. The four overcurrent sensing circuits 54 through 57 are provided so as to correspond to the four variable logic elements 50 through 53.

Herein, the entirety of the overcurrent sensing circuits 54 through 57 constitute an output controlling circuit.

A under-verification circuit that becomes an object to be verified by the logic emulator 5 is divided and assigned to the respective variable logic elements 50 through 53.

In detail, a under-verification sub-circuit A is assigned to the variable logic element 50. A under-verification sub-circuit B is assigned to the variable logic element 51. A under-verification sub-circuit C is assigned to the variable logic element 52. A under-verification sub-circuit D is assigned to the variable logic element 53.

Next, a description is given of connections.

The overcurrent sensing circuits 54 through 57 are connected to output enable terminals (hereinafter called “OE terminals”) 58 through 61 of the corresponding variable logic elements 50 through 53 by wirings 66 through 69, and control signals generated by the overcurrent sensing circuits 54 through 57 are given to the corresponding OE terminals 58 through 61.

The overcurrent sensing circuits 54 through 57 and power supply 76 are connected to each other by a power supply line 75. And, the power supply voltage supplied by the power supply 76 through the power supply line 75 is given to power supply terminals 62 through 65 of the variable logic elements 50 through 53 via the overcurrent sensing circuits 54 through 57 and power supply lines 70 through 73. Thus, the variable logic elements 50 through 53 receive power supply voltage.

The variable logic element 50 and variable wiring element 74 are connected to each other by a wiring 107. The variable logic element 51 and variable wiring element 74 are connected to each other by a wiring 108. The variable logic element 52 and variable wiring element 74 are connected to each other by a wiring 110. And the variable logic element 53 and variable wiring element 74 are connected to each other by a wiring 109.

The variable wiring element 74 realizes a wiring between the respective variable logic elements 50 through 53, and the respective variable logic elements 50 through 53 are connected to each other by the variable wiring element 74. The variable wiring element 74 is, for example, an FPID. Further, respective wirings 107 through 110 include a plurality of signal lines.

The variable logic element 50 and external device 1 are connected to each other by a wiring 103. The wiring 103 includes a plurality of signal lines.

The variable logic element 51 and external device 1 are connected to each other by a wiring 104. The wiring 104 includes a plurality of signal lines.

Next, a description is given of functions and actions of respective constructions. A description is given of the logic emulator 5.

The variable logic elements 50 through 53 are elements for altering the logic internally emulated, and emulate the functions based on the set logic.

That is, the variable logic elements 50 through 53 are similar to the variable logic elements 20 and 21 in FIG. 1.

The overcurrent sensing circuits 54 through 57 monitor the consumption currents of the corresponding variable logic elements 50 through 53, and give a control signal, by which the outputs of the corresponding variable logic elements 50 through 53 are made into high impedance, to the OE terminals 58 through 61 of the corresponding variable logic elements 50 through 53 when the levels of the consumption currents of the corresponding variable logic elements 50 through 53 exceed prescribed thresholds. The variable logic elements that receive the control signal make the outputs into high impedance.

On the other hand, the overcurrent sensing circuits 54 through 57 give a control signal, which brings about a state enabling verification work (that is, a normal state), to the OE terminals 58 through 61 of the corresponding variable logic elements 50 through 53 when the level of the consumption currents of the corresponding variable logic elements 50 through 53 do not exceed the prescribed thresholds. The variable logic element that receives the control signal is made into a normal state.

Hereinafter, a detailed description is given of the following points.

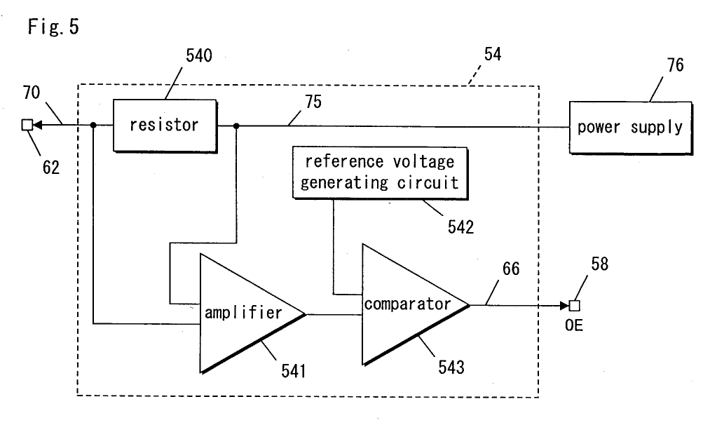

FIG. 5 is a view illustrating an overcurrent sensing circuit of FIG. 4. Also, in FIG. 5, parts which are the same as those in FIG. 4 are given the same reference numbers.

As shown in FIG. 5, the overcurrent sensing circuit 54 includes a resistor 540, an amplifier 541, a reference voltage generating circuit 542 and a comparator 543.

Next, a description is given of connections thereof.

One end of the resistor 540 is connected to the power supply 76 by the power supply line 75, and the other end thereof is connected to the power supply terminal 62 of the variable logic element 50 by the power supply line 70.

One input of the amplifier 541 is connected to one end of the resistor 540, and the other input thereof is connected to the other end of the resistor 540. Output of the amplifier 541 is connected to one input of the comparator 543.

The other input of the comparator 543 is connected to the reference voltage generating circuit 542. Output of the comparator 543 is connected to the OE terminal 58 of the variable logic element 50 by the wiring 66.

Next, a description is given of functions and actions thereof.

The resistor 540 is to know the intensity of a current flowing into the variable logic element 50 on the basis of a potential difference between both ends thereof. That is, the potential difference between both ends of the resistor 540 is a voltage corresponding to the consumption current of the variable logic element 50.

The resistance value of the resistor 540 is set to a sufficiently small value so that it does not influence operations of the variable logic element 50 by voltage drop due to the consumption current in a normal operating state of the variable logic element 50. The normal operating state means an appropriate operating state generated when no excessive current flows into the variable logic element 50.

The amplifier 541 amplifies the potential difference between both ends of the resistor 540. The comparator 543 compares the potential difference between both ends of the resistor 540, which is amplified by the amplifier 541, with the reference voltage (hereinafter called a “prescribed threshold voltage”) generated by the reference voltage generating circuit 542.

And, the comparator 543 gives a control signal, which makes the output of the variable logic element 50 into high impedance, to the OE terminal 58 of the variable logic element 50 when the level of the potential difference between both ends of the resistor 540, which is amplified by the amplifier 541, exceeds the level of the prescribed threshold voltage.

Thus, the comparator 543 makes the output of the variable logic element 50 into high impedance when the level of the voltage obtained by amplifying the voltage corresponding to the consumption current of the variable logic element 50 exceeds the level of the prescribed threshold voltage.

Here, the prescribed threshold is determined in view of the following point. If signals are collided with each other between the variable logic element 50 and variable wiring element 74 or between the variable logic element 50 and the external device 1, the current flowing into the variable logic element 50 becomes larger than the current flowing in a normal operating state.

If so, the potential difference between both ends of the resistor 540 becomes larger than that in the normal operating state. That is, by monitoring the potential difference between both ends of the resistor 540, it is possible to detect that an excessive current flows into the variable logic element 50. The present embodiment utilizes this point.

In addition, the normal operating state means an appropriate operating state generated when no excessive current flows into the variable logic element 50.

Accordingly, the prescribed threshold voltage is set to a voltage responsive to the potential difference between both ends of the resistor 540 when the variable logic element 50 is in its normal operating state.

That is, the prescribed threshold voltage is set to a voltage responsive to the consumption current of the variable logic element 50 in the normal operating state.

Thereby, where a larger current than that in the normal operating state flows into the variable logic element 50, the output of the variable logic element 50 is made into high impedance.

For this reason, it is possible to further securely prevent signals from being colliding with each other between the variable logic element 50 and variable wiring element 74, and between the variable logic element 50 and the external device 1, wherein it is possible to further securely prevent an excessive current from continuously flowing into the variable logic element 50, variable wiring element 74 and external device 1.

Resultantly, it is possible to further securely prevent the logic emulator 5 and external device 1 from being damaged or broken, wherein verification work of the under-verification circuit can be smoothly carried out.

Here, for example, the prescribed threshold voltage is determined on the basis of experience.

On the other hand, the comparator 543 gives a control signal, which makes the variable logic element 50 into a state enabling verification work (a normal state), to the OE terminal 58 of the variable logic element 50 when the level of the potential difference between both ends of the resistor 540, which is amplified by the amplifier 541, does not exceed the prescribed threshold voltage.

Also, the respective constructions and actions of the overcurrent sensing circuits 55 through 57 are similar to those of the overcurrent sensing circuit 54 in FIG. 5. Also, the prescribed threshold in the overcurrent sensing circuits 55 through 57 is set by the same manner as that of setting the prescribed threshold in the overcurrent sensing circuit 54 in FIG. 5.

Next, a detailed description is given of the reference voltage generating circuit 542 in FIG. 5.

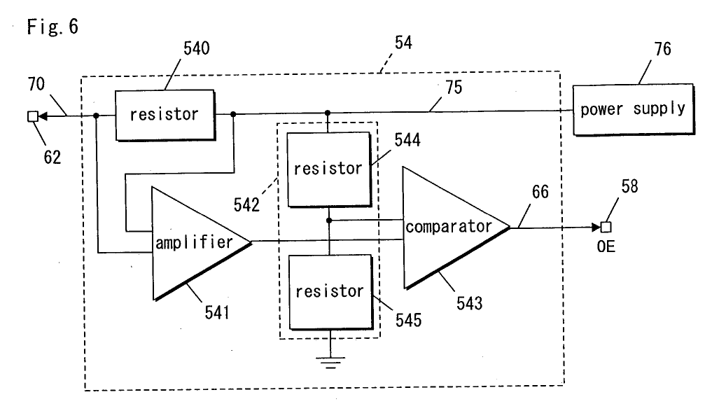

FIG. 6 is a view illustrating a reference voltage generating circuit of FIG. 5. Also, in FIG. 6, parts which are the same as those in FIG. 5 are given the same reference numbers.

As shown in FIG. 6, the reference voltage generating circuit 542 includes resistors 544 and 545.

One end of the resistor 544 is connected to the power supply line 75. The other end thereof is connected to one input of the comparator 543 and one end of the resistor 545. The other end of the resistor 545 is grounded.

Thus, the power supply voltage is divided into prescribed sizes by the resistors 544 and 545 to generate a prescribed threshold voltage which will be given to one input of the comparator 543.

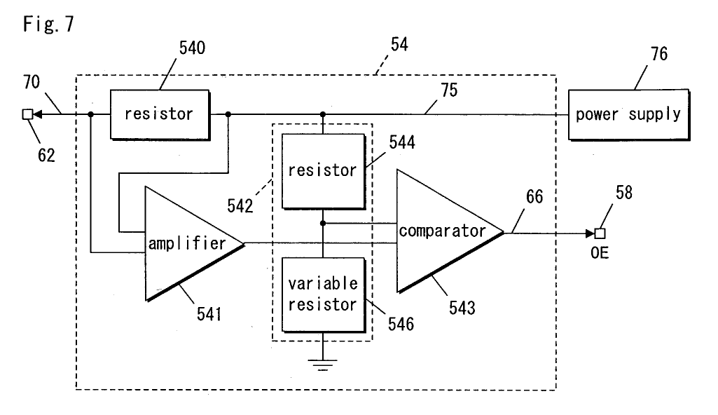

FIG. 7 is another view illustrating reference voltage generating circuit 542 of FIG. 5. In FIG. 7, parts which are the same as those in FIG. 5 are given the same reference numbers.

As shown in FIG. 7, the reference voltage generating circuit 542 includes a resistor 544, and a variable resistor 546.

One end of the resistor 544 is connected to the power supply line 75, and the other end thereof is connected to one input of the comparator 543 and one end of the variable resistor 546. The other end of the variable resistor 546 is grounded.

Thus, the power supply voltage is divided into prescribed sizes by the resistors 544 and variable resistor 546 to generate a prescribed threshold voltage which will be given to one input of the comparator 543.

In FIG. 7, since a variable resistor 576 is provided instead of the resistor 545 in FIG. 6, it is possible to set the prescribed threshold voltage to an optional value by varying the resistance value thereof.

Therefore, it becomes possible to set the prescribed threshold voltages in response to the under-verification sub-circuits A through D and verification environment.

Thereby, appropriate prescribed threshold voltages responsive to the under-verification sub-circuits A through D and verification environment can be compared with the voltages responsive to the consumption current of the variable logic elements 50 through 53.

As described above, in the present embodiment, the output controlling circuit detects voltage (the quantity of electricity) responsive to the consumption current for each of the variable logic elements 50 through 53 and, when the level of the detected voltage (the quantity of electricity) exceeds the level of the prescribed threshold voltage, makes the outputs of the variable logic elements 50 through 53, the voltages (the quantity of electricity) of which are detected, into high impedance.

In further detail, the output controlling circuit consists of four overcurrent sensing circuits 54 through 57 provided so as to correspond to the four variable logic elements 50 through 53.

And, the respective overcurrent sensing circuits 54 through 57 detect voltages (the quantity of electricity) responsive to the consumption current of the corresponding variable logic elements 50 through 53, and make the outputs of the corresponding variable logic elements 50 through 53 into high impedance when the levels of the voltages (the quantity of electricity) of the corresponding variable logic elements 50 through 53 exceed the level of the prescribed threshold voltage.

Thereby, if the prescribed threshold voltage is set so that, when an excessive current flows into the variable logic elements 50 through 53, the corresponding overcurrent sensing circuits 54 through 57 make the outputs of the variable logic elements 50 through 53 into high impedance, the outputs of the variable logic elements 50 through 53 are made into high impedance when an excessive current flows into the variable logic elements 50 through 53.

For this reason, it is possible to prevent signals from being colliding with each other between each of the variable logic elements 50 through 53 and variable wiring element 74, and between each of the variable logic elements 50 through 53 and the external device 1, wherein it is possible to prevent an excessive current from continuously flowing into the variable logic elements 50 through 53, variable wiring element 74 and external device 1.

Resultantly, it is possible to prevent the logic emulator 5 and external device 1 from being damaged or broken, wherein verification work of the under-verification circuit can be smoothly carried out.

Also, the present embodiment employs variable connecting elements as means for connecting between respective variable logic elements. However, even if the respective variable logic elements are directly connected to each other, the embodiment is applicable thereto.

In addition, even if connections made by variable connecting elements and direct connection are combined, the embodiment is also applicable.

The number of variable logic elements is not limited to four. The embodiment may be applicable to any optional number.

Further, the embodiment may be applicable to a case where all the variable logic elements are not connected to an external device.

Still further, in the above, a case where an excessive current flows into variable logic elements is explained for instance as a cause of collisions of signals. However, it is as a matter of course that, even if an excessive current flows by a cause other than collision of signals, the embodiment can operate and can bring about and display effects similar to the above.

(Embodiment 5)

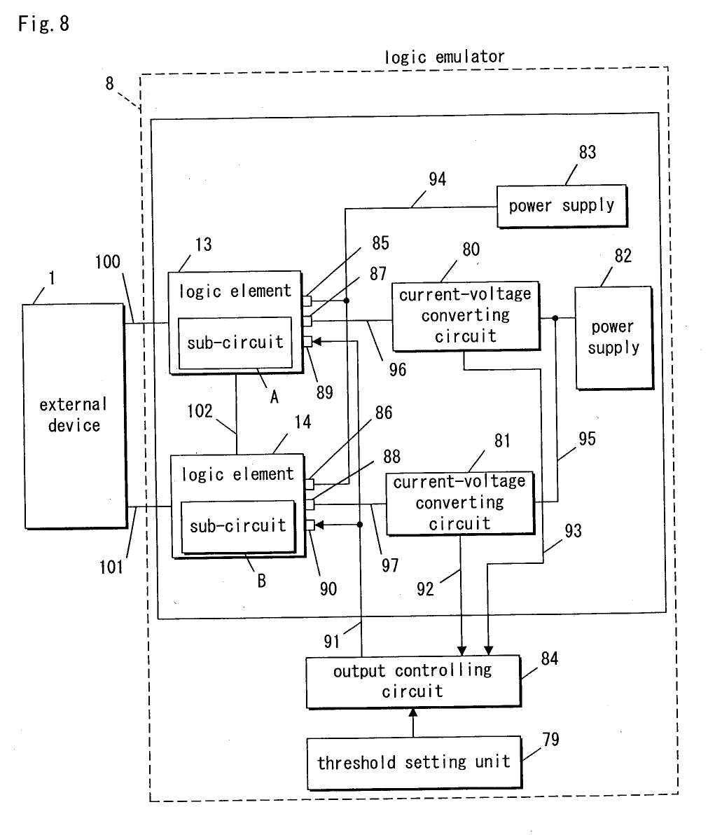

FIG. 8 is a block diagram of a logic emulator according to Embodiment 5 of the present invention. Also, in FIG. 8, parts which are similar to those in FIG. 1 are given the same reference numbers, and description thereof is appropriately omitted.

As shown in FIG. 8, the logic emulator 8 includes variable logic elements 13 and 14, current-voltage converting circuits 80 and 81, power supplies 82 and 83, an output controlling unit 84, and a threshold setting unit 79.

Next, a description is given of connections thereof.

The variable logic elements 13 and 14 are connected to each other by a wiring 102. The external device 1 and variable logic element 13 are connected to each other by a wiring 100. The external device 1 and variable logic element 14 are connected to each other by a wiring 101. Also, the wiring 102 includes a plurality of signal lines, and wirings 100 and 101 respectively include a plurality of signal lines.

A under-verification circuit is divided and assigned to the respective variable logic elements 13 and 14. In detail, a under-verification sub-circuit A is assigned to the variable logic element 13, and a under-verification sub-circuit B is assigned to the variable logic element 14.

The power supply 83 and power supply terminals 85 and 86 of the variable logic elements 13 and 14 are connected by a power supply line 94. Power supply voltage is supplied by the power supply 83 to logic emulating circuits, described later, of the variable logic elements 13 and 14 via the power supply line 83 and power supply terminals 85 and 86.

The power supply 82 and current-voltage converting circuits 80 and 81 are connected to each other by the power supply line 95. And, the power supply voltage supplied by the power supply 82 through the power supply line 95 is given to the power supply terminals 87 and 88 of the variable logic elements 13 and 14 via the current-voltage converting circuits 80 and 81 and power supply lines 96 and 97.

Power supply voltage is supplied by the power supply 82 to input/output circuits (I/O circuits), described later, of the variable logic elements 13 and 14 via the power supply line 95, current-voltage converting circuits 80 and 81, and power supply terminals 87 and 88.

The current-voltage converting circuits 80 and 81 and output controlling unit 84 are connected by the wirings 93 and 92. The output controlling unit 84 and output enable terminals (hereinafter called “OE terminals”) 89 and 90 of the variable logic elements 13 and 14 are connected to each other by the wiring 91.

Next, a detailed description is given of the variable logic element 13.

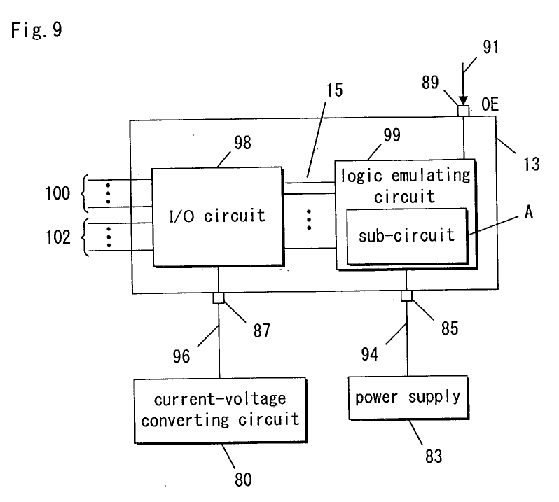

FIG. 9 is a block diagram of a variable logic element 13 of FIG. 8. Also, in FIG. 9, parts which are the same as those in FIG. 8 are given the same reference numbers, and description thereof is appropriately omitted.

As shown in FIG. 9, the variable logic element 13 includes the input/output circuit (hereinafter called an “I/O circuit”) 98 and logic emulating circuit 99. A under-verification sub-circuit A is assigned to the logic emulating circuit 99.

The logic emulating circuit 99 is connected to the I/O circuit 98 by the wiring 15. The I/O circuit 98 is connected to the external device 1 in FIG. 8 by the wiring 100. The I/O circuit 98 is connected to the variable logic element 14 in FIG. 8 by the wiring 102. Also, the wiring 15 includes a plurality of signal lines, which are composed of a plurality of signal lines corresponding to the plurality of signal lines of the wiring 100 and a plurality of signal lines corresponding to the plurality of signal lines of the wiring 102.

Power supply voltage is supplied from the power supply 82 in FIG. 8 to the I/O circuit 98 via the current-voltage converting circuit 80, power supply line 96, and power supply terminal 87.

On the other hand, power supply voltage is supplied from the power supply 83 to the logic emulating circuit 99 via the power supply line 94 and power supply terminal 85.

Thus, a different power supply voltage is, respectively, given to the I/O circuit 98 and the logic emulating circuit 99 from different power supplies 82 and 83.

Also, a control signal is given from the output controlling unit 84 to the logic emulating circuit 99 via the wiring 91 and OE terminal 89.

The variable logic element 13 is an element for altering the logic that is internally emulated and emulates functions based on the set logic. That is, the variable logic element 13 is similar to the variable logic elements 20 and 21 in FIG. 1.

In detail, the variable logic element 13 is a combination of a circuit (logic cell) operable to program the functions, a signal line (program wiring) operable to program the connections, and a programmable input/output circuit (programmable I/O).

The I/O circuit 98 corresponds to the programmable I/O, and the logic emulating circuit 99 corresponds to the logic cell and programmable wiring.

In addition, the construction and actions of the variable logic element 14 in FIG. 8 are similar to those of the variable logic element 13 in FIG. 9. Therefore, hereinafter, the same reference numbers as those of the I/O circuit 98 and logic emulating circuit 99 of the variable logic element 13 are given to the I/O circuit and logic emulating circuit of the variable logic element 14 for description thereof.

Next, referring to FIG. 8 and FIG. 9, a description is given of the functions and actions of the respective constructions.

The current-voltage converting circuit 80 converts the consumption current of the I/O circuit 98 of the variable logic element 13 to a voltage corresponding thereto (hereinafter called “consumption current data”). The current-voltage converting circuit 81 converts the consumption current of the I/O circuit 98 of the variable logic element 14 to a voltage corresponding thereto.

The consumption current data are given to the output controlling unit 84 by wirings 93 and 92.

The output controlling unit 84 includes a prescribed threshold corresponding to a predicted value of the consumption current of the I/O circuit 98 of the variable logic element 13 and a prescribed threshold corresponding to a predicted value of the consumption current of the I/O circuit 98 of the variable logic element 14.

And, the output controlling unit 84 compares the consumption current data with the prescribed threshold for each of the variable logic elements 13 and 14, and gives a control signal, which makes the output of the I/O circuit 98 of the variable logic element into high impedance, to the OE terminal of the variable logic element where consumption current data exceeding the prescribed threshold is detected, when the level of the consumption current data exceed the prescribed threshold. The variable logic element that receives the control signal makes the output of the I/O circuit 98 into high impedance.

In further detail, the output controlling unit 84 gives a control signal to the OE terminal of the variable logic element whose consumption current data exceeding the prescribed threshold is detected, and controls the output of the logic emulating circuit 99 of the variable logic element so that the output of the I/O terminal 98 of the variable logic element is made into high impedance.

Also, the output controlling unit 84 gives a control signal to the OE terminals of all the variable logic elements 13 and 14 when the level of the consumption current data detected from any one of the variable logic elements 13 and 14 exceeds the prescribed threshold, wherein the outputs of the I/O circuits 98 of all the variable logic elements 13 and 14 may be made into high impedance.

On the other hand, the output controlling unit 84 gives to the OE terminals 89 and 90 of the variable logic elements 13 and 14 a control signal for bringing about a state (normal state) operable to carry out verification work when the level of the consumption current data does not exceed the prescribed threshold. The variable logic element that receives the control signal is made into its normal state.

Here, the above-described prescribed threshold that the output controlling unit 84 uses is given by the threshold setting unit 79.

The threshold setting unit 79 obtains the predicted values of consumption currents of the I/O circuits 98 of the variable logic elements 13 and 14.

That is, a consumption current per signal line is acquired by an experiment or a calculation where a wiring between the respective variable logic elements 13 and 14 and a wiring between each of the variable logic elements 13 and 14 and the external device 1 are driven at a fixed cycle of, for example, H (High) R L (Low) R H (High) R L (Low) at 1 MHz.

And, on the basis of information of the under-verification sub-circuits A and B assigned to the variable logic elements 13 and 14 by the threshold setting unit 79, the output terminal number of the respective variable logic elements 13 and 14 and the maximum operating frequency are obtained, and predicted values of the consumption currents of the I/O circuits 98 of the variable logic elements 13 and 14 are calculated by the following expression for each of the variable logic elements 13 and 14.

PV=CC×OTM×MOF [Expression 1]

PV: predicted value

CC: consumption current per one signal line at 1 MHz

OTM: output terminal number of variable logic element

MOF: maximum operating frequency [MHz]

The threshold setting unit 79 calculates a prescribed threshold corresponding to the predicted value on the basis of the predicted value of the consumption current obtained by [Expression 1].

Here, as an example, the above-described output controlling unit 84 and threshold setting unit 79 may be composed of a workstation. In this case, processes in the output controlling unit 84 and threshold setting unit 79 are carried out by programs on the workstation.

In this case, the consumption current data (analog signal) outputted by the current-voltage converting circuits 80 and 81 are given to an A/D converting substrate (not illustrated) inserted into an expansion slot (not illustrated) of the workstation by wirings 93 and 92 and are converted to a digital signal.

And, the workstation reads the consumption current data of the I/O circuits 98 of the variable logic elements 13 and 14 from the A/D converting substrate, and gives a control signal to the variable logic element, whose consumption current data exceeding the prescribed threshold is detected, via the wiring 91 and OE terminals 89 and 90 from a digital I/O board (not illustrated) inserted into the expansion slot (not illustrated) of the workstation when the level of the consumption current data exceeds the prescribed threshold corresponding to the predicted value of the consumption current, and controls the variable logic elements so that the output of the I/O circuit 98 of the variable logic element is made into high impedance.

As described above, in the present embodiment, the output controlling unit 84 detects the consumption current data (quantity of electricity responsive to the consumption current) for each of the variable logic elements 13 and 14, and makes the outputs of the variable logic elements 13 and 14 whose consumption current data are detected, into high impedance when the level of the detected consumption current data exceeds the prescribed threshold.

In further detail, the output controlling unit 84 detects the consumption current data for each of the I/O circuits 98 of the variable logic elements 13 and 14, and makes the output of the I/O circuit 98 whose consumption current data is detected, into high impedance when the level of the detected consumption current data exceeds the prescribed threshold.

Therefore, if the prescribed threshold is set so that the output of the I/O circuit 98 is made into high impedance when an excessive current flows into the I/O circuit 98 where power supply voltage is supplied from different power supplies to the I/O circuit 98 and logic emulating circuit 99, which are included in the variable logic elements 13 and 14, the output of the I/O circuit 98 is made into high impedance when an excessive current flows into the I/O circuit 98.

For this reason, it is possible to prevent signals from being colliding with each other between the variable logic elements 13 and 14, and between each of the variable logic elements 13 and 14 and the external device 1, wherein it is possible to prevent an excessive current from flowing into the variable logic elements 13 and 14 and external device 1.

Resultantly, it is possible to prevent the logic emulator 8 and external device 1 from being damaged or broken, wherein verification work of the under-verification circuit can be smoothly carried out.

Further, in the present embodiment, the threshold setting unit 79 sets the prescribed threshold for each of the variable logic elements 13 and 14 in response to the predicted value of consumption current for each of the variable logic elements 13 and 14.

Accordingly, an appropriate prescribed threshold responsive to the predicted value of consumption current for each of the variable logic elements 13 and 14 is compared with the consumption current data detected from the corresponding variable logic elements 13 and 14.

Thereby, it is possible to further accurately detect that an excessive current flows into the variable logic elements 13 and 14.

Therefore, it is possible to further securely prevent signals from being colliding with each other between the variable logic elements 13 and 14, and between each of the variable logic elements 13 and 14 and the external device 1, wherein it is possible to further securely prevent an excessive current from flowing into the variable logic elements 13 and 14 and external device 1.

Resultantly, it is possible to further securely prevent the logic emulator 8 and external device 1 from being damaged or broken, wherein verification work of the under-verification circuit can be further smoothly carried out.

Also, the threshold setting unit 79 predicts the consumption currents of the variable logic elements 13 and 14. Therefore, it is possible to reduce time and effort assigned to a user of a logic emulator 8 as much as possible.

Further, the number of variable logic elements is not limited to two. The present embodiment may be applicable to an optional number.

Still further, the present embodiment may be applicable to a case where all the variable logic elements are not connected to an external device.

In addition, the present embodiment may be applicable even in a case where connections between the respective variable logic elements are realized by using exclusive variable wiring elements. The variable wiring element may be, for example, FPID.

Also, in the above description, a case where an excessive current flows into the variable logic elements is taken for instance as a cause of collisions of signals. However, it is as a matter of course that, even if an excessive current flows by a cause other than the collisions of signals, the present embodiment can bring about and display effects as in the above.

(Embodiment 6)

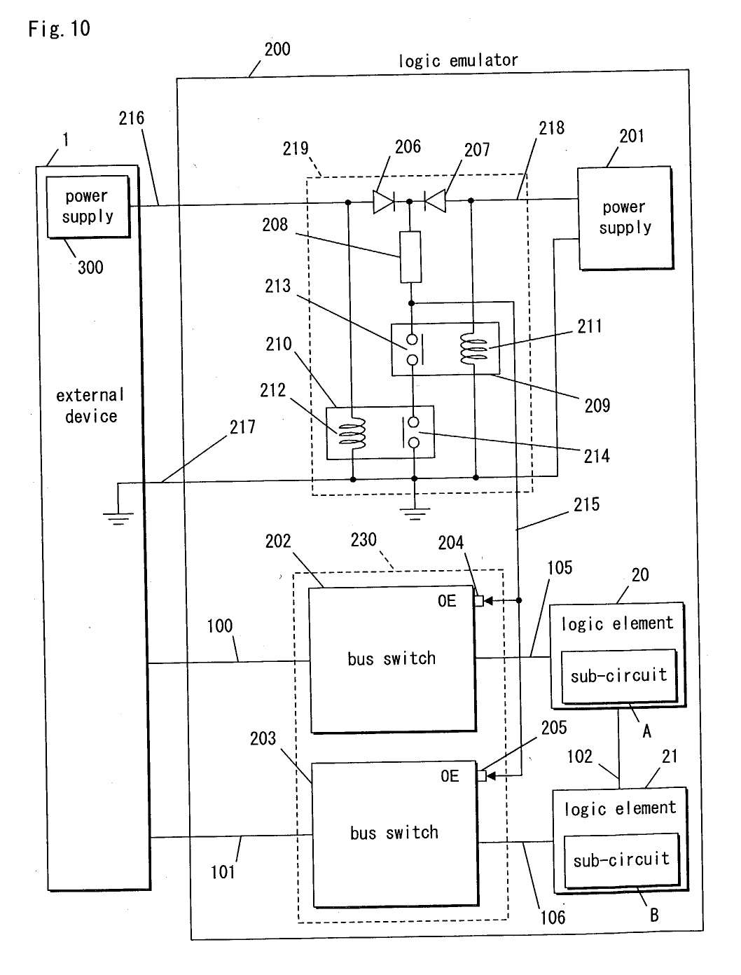

FIG. 10 is a block diagram of a logic emulator according to Embodiment 6 of the present invention. Also, in FIG. 10, parts which are similar to those in FIG. 1 are given the same reference number, and description thereof is appropriately omitted.

As shown in FIG. 10, the logic emulator 200 includes a power ON/OFF sensing circuit 219, a power supply 201, a switching circuit 230, and variable logic elements 20 and 21.

The power supply ON/OFF sensing circuit 219 includes diodes 206 and 207, a resistor 208, and relays 209 and 210.

The relay 209 includes a contact 213 and a coil 211. The relay 210 includes a contact 214 and a coil 212.

The switching circuit 230 includes bus switches 202 and 203. The bus switches 202 and 203 are provided with respect to the variable logic elements 20 and 21.

A description is given of connections thereof.

The anode terminal of the diode 207 and one end of the coil 211 are connected to the power supply line 218, wherein power supply voltage is given from the power supply 201 thereto. The other end of the coil 211 is connected to the ground.

The cathode terminals of the diodes 206 and 207 are connected to one end of the resistor 208. The other end of the resistor 208 is connected to one end of the contact 213, and at the same time, is connected to output enable terminals (hereinafter called “OE terminals”) 204 and 205 of the bus switches 202 and 203 by a wiring 215.

The other end of the contact 213 is connected to one end of the contact 214. The other end of the contact 214 is connected to the ground.

The anode terminal of the diode 206 is connected to the power supply 300 of the external device 1 by a wiring 216, and at the same time, is connected to one end of the coil 212. The other end of the coil 212 is connected to the ground.

The ground of the external device 1 is connected to the ground of the logic emulator 200 by a wiring 217.

The variable logic elements 20 and 21 are connected to each other by a wiring 102. Also, the wiring 102 includes a plurality of signal lines.

The variable logic element 20 and external device 1 are connected to each other via the wiring 105, bus switch 202 and wiring 100. The wiring 105 includes a plurality of signal lines. The wiring 100 also includes a plurality of signal lines with respect to the above-described plurality of signal lines.

The variable logic element 21 and external device 1 are connected to each other via the wiring 106, bus switch 203 and wiring 101. The wiring 106 includes a plurality of signal lines. The wiring 101 also includes a plurality of signal lines with respect to the above-described plurality of signal lines.

A description is given of the basic actions of the above-described construction.

In the relay 209, the contact 213 is turned on when the power supply 201 of the logic emulator 200 is turned on, and the contact 213 is turned off when the power supply 201 of the logic emulator 200 is turned off.

In the relay 210, the contact 214 is turned on when the power supply 300 of the external device 1 is turned on, and the contact 214 is turned off when the power supply 300 of the external device 1 is turned off.

Also, the power supply 201 supplies power supply voltage to the variable logic elements 20 and 21.

Next, a detailed description is given of the bus switch 202.

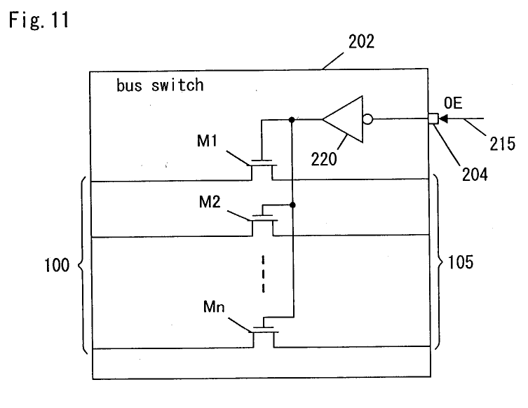

FIG. 11 is a view illustrating a bus switch 202 of FIG. 10. Also, parts which are the same as those in FIG. 10 are given the same reference number.

As shown in FIG. 11, the bus switch 202 includes an inverter 220 and a plurality of NMOS transistors M1 through Mn (n is a natural number).

Input of the inverter 220 is connected to the OE terminal 204 while output of the inverter 220 is connected to the gates of NMOS transistors M1 through Mn.

Electrodes at one side of the NMOS transistors M1 through Mn are connected to the corresponding signal lines of the wiring 100, and electrodes at the other side thereof are connected to the corresponding signal lines of the wiring 105.

The NMOS transistors M1 through Mn are turned on when the input to the OE terminal 204 is at the L (Low) level, wherein the signal lines of the wiring 100 are connected to the corresponding signal lines of the wiring 105.

On the other hand, the NMOS transistors M1 through Mn are turned off when the input to the OE terminal 204 is at the H (High) level, wherein the wiring 100 and wiring 105 are not connected.

Also, the construction and action of the bus switch 203 are similar to those of the bus switch 202 in FIG. 11.

Next, a description is given of the entire actions with reference to FIG. 10 and FIG. 11.

First, a description is given of actions where the power supply 300 of the external device 1 is turned on and the power supply 201 of the logic emulator 200 is turned off.

In this case, a current flows into the coil 212 of the relay 210, wherein the contact 214 is turned on. However, the contact 213 of the relay 209 remains off.

Therefore, power supply voltage of the external device 1 is transmitted to the OE terminals 204 and 205 of the bus switches 202 and 203 in the course of the wiring 216, diode 206, resistor 208, and wiring 215.

Thereby, the potential of the wiring 215 is fixed at the H (High) level, and the inputs into the OE terminals 204 and 205 of the bus switches 202 and 203 are fixed at the H (High) level.

Thus, the bus switches 202 and 203 are turned off, wherein the variables 20 and 21 of the logic emulator 200 and the external device 1 are not connected to each other.

Next, a description is given of a case where the power supply 300 of the external device 1 is turned off, and the power supply 201 of the logic emulator 200 is turned on.

In this case, although a current flows into the coil 211 of the relay 209 and the contact 213 is turned on, the contact 214 of the relay 210 remains off.

Therefore, the power supply voltage of the logic emulator 200 is transmitted to the OE terminals 204 and 205 of the bus switches 202 and 203 in the course of the power supply line 218, diode 207, resistor 208, and wiring 215.

Thereby, the potential of the wiring 215 is fixed at the H (High) level, and the inputs into the OE terminals 204 and 205 of the bus switches 202 and 203 are fixed at the H (High) level.

Thus, the bus switches 202 and 203 are turned off, wherein the variable logic elements 20 and 21 of the logic emulator 200 and the external device 1 are not connected to each other.

Next, a description is given of a case where the power supply 300 of the external device 1 is turned off and the power supply 201 of the logic emulator 200 is turned off.

In this case, the contact 213 of the relay 209 and contact 214 of the relay 210 are turned off.

Next, a description is given of a case where the power supply 300 of the external device 1 is turned on and the power supply 201 of the logic emulator 200 is turned on.

In this case, a current flows into the coil 211 of the relay 209, wherein the contact 213 is turned on, and a current flows into the coil 212 of the relay 210, wherein the contact 214 is turned on.

Therefore, the potential of the wiring 215 is fixed at the L (Low) level, and the inputs into the OE terminals 204 and 205 of the bus switches 202 and 203 are fixed at the L (Low) level.

Thereby, the bus switches 202 and 203 are turned on, wherein the variable logic elements 20 and 21 of the logic emulator 200 and the external device 1 are connected to each other.

Thus, in the present embodiment, the switching circuit 230 (bus switches 202 and 203) connects the variable logic elements 20 and 21 and the external device 1 to each other only when both the power supply 300 of the external device 1 and the power supply 201 of the variable logic elements 20 and 21 are turned on.

And, when any one of the power supply 300 of the external device 1 and the power supply 201 of the variable logic elements 20 and 21 is turned off and the other is turned on, the variable logic elements 20 and 21 and the external device 1 are not connected to each other.

For this reason, where one of the power supply 300 of the external device 1 and the power supply 201 of the variable logic elements 20 and 21 is turned off and the other thereof is turned on, it is possible to prevent an excessive current from flowing from the side where the power supply is turned on to the side where it is turned off via wirings 100 and 101 by which each of the variable logic elements 20 and 21 and the external device 1 are connected.

Resultantly, it is possible to prevent the variable logic elements 20 and 21 and the external device 1 from being damaged or broken, wherein verification work of a under-verification circuit can be smoothly carried out.

Also, the number of variable logic elements is not limited to two. The present embodiment may be applicable to any optional number.

Also, the embodiment is applicable to a case where a part of the variable logic elements does not constitute any connection with the external device.

In addition, the embodiment is applicable to a case where connections between the respective variable logic elements are realized by using exclusive variable wiring elements. The variable wiring element may be, for example, FPID.

In a logic emulator according to the first aspect of the invention, if a prescribed value is set so that the output of the variable logic means is made into high impedance when the temperature of the variable logic means is excessively raised, the output of the variable logic means is made into high impedance where an excessive current flows into the variable logic means and the temperature excessively rises.

For this reason, it is possible to prevent signals from being colliding with each other between the-variable logic means, between each of the variable logic means and the external device, and between each of the variable logic means and variable wiring means where any variable wiring means exists, and it is possible to prevent an excessive current from continuously flowing into the variable logic means, external device, and variable wiring means.

As a result, the logic emulator and external device can be prevented from being damaged or broken, wherein verification work of a under-verification circuit can be smoothly carried out.

In a logic emulator according to the second aspect of the invention, if a prescribed value is set so that the output of the variable logic means is made into high impedance when the temperature of the variable logic means is excessively raised, the outputs of all the variable logic means are made into high impedance when an excessive current flows into the variable logic means and the temperature thereof excessively rises.

For this reason, it is possible to prevent signals from being colliding with each other between the variable logic means, between each of the variable logic means and the external device, and between each of the variable logic means and variable wiring means where any variable wiring means exists, and it is possible to prevent an excessive current from continuously flowing into the variable logic means, external device, and variable wiring means.

As a result, the logic emulator and external device can be prevented from being damaged or broken, wherein verification work of a under-verification circuit can be smoothly carried out.

In a logic emulator according to the third aspect of the invention, it becomes possible to set a prescribed value in response to sub-circuits (under-verification sub-circuits) assigned to respective variable logic means by dividing a under-verification circuit, and verification environment.

In a logic emulator according to the fourth aspect of the invention, an appropriate prescribed value responsive to a predicted value of operating temperatures of each of the variable logic means is compared with quantity of electricity responsive to the temperature detected from the corresponding variable logic means.

For this reason, it is possible to further accurately detect that an excessive current flows into the variable logic means and the temperature thereof excessively rises.

Therefore, it is possible to further securely prevent signals from being colliding with each other between the variable logic means, between each of the variable logic means and the external device, and between each of the variable logic means and variable wiring means where any variable wiring means exists, and it is possible to further securely prevent an excessive current from continuously flowing into the variable logic means, external device, and variable wiring means.

As a result, the logic emulator and external device can be prevented from being damaged or broken, wherein verification work of a under-verification circuit can be further smoothly carried out.

In a logic emulator according to the fifth aspect of the invention, an appropriate prescribed value responsive to the ambient temperature is compared with the quantity of electricity responsive to the temperature detected from the variable logic means.

For this reason, it is possible to further accurately detect that an excessive current flows into the variable logic means and the temperature thereof excessively rises.

Therefore, it is possible to further securely prevent signals from being colliding with each other between the variable logic means, between each of the variable logic means and the external device, and between each of the variable logic means and variable wiring means where any variable wiring means exists, and it is possible to further securely prevent an excessive current from continuously flowing into the variable logic means, external device, and variable wiring means.

As a result, the logic emulator and external device can be prevented from being damaged or broken, wherein verification work of a under-verification circuit can be further smoothly carried out.

In a logic emulator according to the sixth aspect of the invention, if a prescribed value is set so that the output of the variable logic means is made into high impedance when an excessive current flows into the variable logic means, the output of the variable logic means is made into high impedance when an excessive current flows into the variable logic means.

For this reason, it is possible to prevent signals from being colliding with each other between the variable logic means, between each of the variable logic means and the external device, and between each of the variable logic means and variable wiring means where any variable wiring means exists, and it is possible to prevent an excessive current from flowing into the variable logic means, external device, and variable wiring means.

As a result, the logic emulator and external device can be prevented from being damaged or broken, wherein verification work of a under-verification circuit can be smoothly carried out.

Also, judging means for making the output of the variable logic means into high impedance is not the temperature of the variable logic means, but the consumption current thereof.

Resultantly, without any time lag until the temperature of the variable logic means rises since a current flowing into the variable logic means becomes excessive, it is possible to detect that the current flowing into the variable logic means is excessive.

In a logic emulator according to the seventh aspect of the invention, if a prescribed value is set so that the output of the variable logic means is made into high impedance when an excessive current flows into the variable logic means, the outputs of all the variable logic means are made into high impedance when an excessive current flows into the variable logic means.

For this reason, it is possible to prevent signals from being colliding with each other between the variable logic means, between each of the variable logic means and the external device, and between each of the variable logic means and variable wiring means where any variable wiring means exists, and it is possible to prevent an excessive current from flowing into the variable logic means, external device, and variable wiring means.

As a result, the logic emulator and external device can be prevented from being damaged or broken, wherein verification work of a under-verification circuit can be smoothly carried out.

In a logic emulator according to the eighth aspect of the invention, it becomes possible to set a prescribed value in response to sub-circuits (under-verification sub-circuits) assigned to respective variable logic means by dividing a under-verification circuit, and verification environment.

In a logic emulator according to the ninth aspect of the invention, an appropriate prescribed value responsive to a predicted value of consumption current of each of the variable logic means is compared with a quantity of electricity responsive to the consumption current detected from the corresponding variable logic means.

For this reason, it is possible to further accurately detect that an excessive current flows into the variable logic means.

Therefore, it is possible to further securely prevent signals from being colliding with each other between the variable logic means, between each of the variable logic means and the external device, and between each of the variable logic means and variable wiring means where any variable wiring means exists, and it is possible to further securely prevent an excessive current from flowing into the variable logic means, external device, and variable wiring means.

As a result, the logic emulator and external device can be prevented from being damaged or broken, wherein verification work of a under-verification circuit can be further smoothly carried out.

In a logic emulator according to the tenth aspect of the invention, if a prescribed value is set so that the corresponding overcurrent sensing means makes the output of the variable logic means into high impedance when an excessive current flows into the variable logic means, the output of the variable logic means is made into high impedance where an excessive current flows into the variable logic means.

For this reason, it is possible to prevent signals from being colliding with each other between the variable logic means, between each of the variable logic means and the external device, and between each of the variable logic means and variable wiring means where any variable wiring means exists, and it is possible to prevent an excessive current from flowing into the variable logic means, external device, and variable wiring means.

As a result, the logic emulator and external device can be prevented from being damaged or broken, wherein verification work of a under-verification circuit can be smoothly carried out.

In a logic emulator according to the eleventh aspect of the invention, if the prescribed value is set so that the output of the inputting and outputting means is made into high impedance when an excessive current flows into the inputting and outputting means in the case where the inputting and outputting means and logic emulating means, which are included in the variable logic means, are given power supply voltage from different power supplies, the output of the inputting and outputting means is made into high impedance where an excessive current is caused to flow into the inputting and outputting means.

For this reason, it is possible to prevent signals from being colliding with each other between the variable logic means, between each of the variable logic means and the external device, and between each of the variable logic means and variable wiring means where any variable wiring means exists, and it is possible to prevent an excessive current from flowing into the variable logic means, external device, and variable wiring means.

As a result, the logic emulator and external device can be prevented from being damaged or broken, wherein verification work of a under-verification circuit can be smoothly carried out.

In a logic emulator according to the twelfth aspect of the invention, where one of the power supply of the external device and the power supply of the variable logic means is turned off, and the other thereof is turned on, the variable logic means and external device are not connected to each other.

Therefore, it is possible to prevent an excessive current from flowing via a wiring, by which the variable logic means and external device are connected, from the side where the power supply is turned on to the side where the power supply is turned off when one of the power supply of the external device and the power supply of the variable logic means is turned off while the other thereof is turned on.

Resultantly, the respective variable logic means and external device can be prevented from being damaged or broken, wherein verification work of a under-verification circuit can be smoothly carried out.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

What is claimed is:

1. A logic emulator connected to an external device for carrying out a verification, comprising:
a under-verification circuit;
a plurality of variable logic units, among which said under-verification circuit is divided and assigned, each variable logic unit being able to alter a logic emulated therein;
a plurality of temperature sensing units provided so as to correspond to a plurality of said variable logic units, respectively, each temperature sensing unit being able to detect the temperature of its corresponding variable logic unit and convert the temperature to a quantity of electricity responsive to the temperature; and
an output controlling unit operable to make the output of said variable logic unit whose temperature is detected, into high impedance when a level of a current amount responsive to the temperature reaches a prescribed level.

2. The logic emulator according to claim 1, wherein said output controlling unit is operable to make the outputs of all said variable logic units into high impedance when the quantity of electricity responsive to the temperature of any one of said variable logic units reaches the prescribed value.

3. The logic emulator according to claim 1, further comprising a prescribed value setting unit operable to set the prescribed value to an optional value.

4. The logic emulator according to claim 3, wherein said prescribed value setting unit is operable to set the prescribed value for each of said variable logic units in response to predicted values of operating temperatures for each of said variable logic units.

5. The logic emulator according to claim 3, wherein said prescribed value setting unit is operable to alter the prescribed value in response to the ambient temperature of an installation place.

6. A logic emulator connected to an external device for carrying out a verification, comprising:
a under-verification circuit;
a plurality of variable logic units, among which said under-verification circuit is divided and assigned, each operable to alter the logic emulated therein; and
an output controlling unit operable to make the output of said variable logic unit whose quantity of electricity is detected, into high impedance when the quantity of electricity responsive to a consumption current is detected for each of said variable logic units and the detected electricity quantity reaches a prescribed value.

7. The logic emulator according to claim 6, wherein said output controlling unit is operable to make the outputs of all said variable logic units into high impedance when the quantity of electricity responsive to the consumption current of any one of said variable logic units reaches the prescribed value.

8. The logic emulator according to claim 6, wherein said output controlling unit comprises a prescribed value setting unit operable to set the prescribed value to an optional value.

9. The logic emulator according to claim 8, wherein said prescribed value setting unit is operable to set said prescribed values for each of said variable logic units in response to predicted values of the consumption current for each of said variable logic units.

10. The logic emulator according to claim 6, wherein said output controlling unit comprises a plurality of overcurrent sensing units provided so as to correspond to said plurality of variable logic units, respectively, and
each said respective overcurrent sensing unit is operable to detect the quantity of electricity responsive to the consumption currents of its corresponding variable logic unit, and make the output of its corresponding variable logic unit into high impedance when the quantity of electricity responsive to the consumption current of its corresponding variable logic unit reaches the prescribed value.

11. The logic emulator according to claim 6, wherein each variable logic unit comprises:
an inputting and outputting unit, which is an input/output interface with the external device, and
a logic emulating unit operable to emulate the logic based on a set logic;
wherein said inputting and outputting unit receives power supply voltage from a power supply differing from the power supply that supplies power supply voltage to said logic emulating unit;
and said output controlling unit is operable to detect the quantity of electricity responsive to the consumption current for each of said inputting and outputting units, and make the output of said inputting and outputting unit whose quantity of electricity is detected, into high impedance when the detected quantity of electricity reaches the prescribed value.

12. A logic emulator connected to an external device for carrying out a verification, comprising:
a under-verification circuit;
a plurality of variable logic units, among which said under-verification circuit is divided and assigned, each operable to alter the logic emulated therein;
a power supply ON and OFF sensing unit operable to sense ON-OFF states of a power supply of the external device and ON-OFF states of a power supply of said variable logic units; and
a switching unit operable to connect said variable logic units and the external device to each other only when both the power supply of the external device and the power supply of said variable logic units are turned on.
